(19) United States
(12) Patent Application Publication
(10) Pub. No.: US 2024/0013095 A1
(43) Pub. Date: Jan. 11, 2024

(54) A SYSTEM AND METHOD FOR THE UNIFICATION AND OPTIMIZATION OF MACHINE LEARNING INFERENCE PIPELINES

(71) Applicant: Saferide Technologies Ltd., Herzliya (IL)

(72) Inventors: Yehiel STEIN, Ramat Hasharon (IL); Yossi VARDI, Tel Aviv (IL); Alexander APARTSIN, Rehovot (IL)

(21) Appl. No.: 18/251,542

(22) PCT Filed: Oct. 3, 2021
(86) PCT No.: PCT/IL21/51188

§ 371 Date: May 3, 2023

Related U.S. Application Data
(60) Provisional application No. 63/109,360, filed on Nov. 4, 2020.

(51) Int. Cl. G06N 20/00; G06N 5/04

(52) U.S. Cl. CPC G06N 20/00; G06N 5/04

(57) ABSTRACT

A system comprising a processing circuitry configured to: obtain one or more MLIPs, each comprised of a sequence of one or more Data Processing Elements (DPEs), and each having (a) at least one input provided to the respective DPE, and (b) at least one output provided by the respective DPE, wherein the output of a given DPE of the DPEs, is the input of a subsequent DPE of the sequence, and wherein at least one of the DPEs is a trained machine learning model; generate, for each of the MLIPs, a respective pipeline representation comprising representations of the sequence, based on the DPEs, the inputs of the DPEs, and the outputs of the DPEs; merge the plurality of MLIP representations into a common representation; optimize the common representation; and generate, based on the common representation, a target model consuming less resources than the MLIPs.

### TECHNICAL FIELD

The invention relates to a system and method for the unification and optimization of machine learning inference pipelines.

### BACKGROUND

A machine learning inference pipeline is a sequence of connected data processing elements. The machine learning inference pipeline can contain several data processing element (e.g. pre-processing models, Machine Learning (ML) models, custom models, custom functions, etc.). One or more machine learning inference pipelines can work together to achieve a goal, for example monitoring vehicle functions for anomalous behaviors based on observed signals.

The machine learning inference pipelines need to be optimized in order to properly deploy on resource constrained platforms, such as an in-vehicle computing device.

Current optimization solutions optimize at the level of individual data processing elements only. This produces sub-optimal optimizations at the machine learning inference pipelines level. There is thus a need in the art for a new method and system for the unification and optimization of machine learning interface pipelines.

### GENERAL DESCRIPTION

In accordance with a first aspect of the presently disclosed subject matter, there is provided a system for unification of machine learning inference pipelines, the system comprising a processing circuitry configured to: obtain one or more machine learning inference pipelines, each comprised of a sequence of one or more data processing elements, and each having (a) at least one input provided to the respective data processing element, and (b) at least one output provided by the respective data processing element, wherein the output of a given data processing element of the data processing elements, is the input of a subsequent data processing element of the sequence, if any, and wherein at least one of the data processing elements is a trained machine learning model; generate, for each of the machine learning inference pipelines, a respective pipeline representation comprising representations of the sequence, based on the data processing elements, the inputs of the data processing elements, and the outputs of the data processing elements; merge the plurality of machine learning inference pipeline representations into a common representation, representing the plurality of machine learning inference pipeline representations; optimize the common representation using one or more optimization schemes; and generate, based on the common representation, a target model, wherein the target model consumes less resources than the machine learning inference pipelines.

In some cases, the optimization schemes include one or more of: (a) quantization; (b) pruning; or (c) knowledge distillation.

In some cases, the knowledge distillation utilizes teacher-student models.

In some cases, the processing circuitry is further configured to: execute a teacher model based on the common representation, on a training set, giving rise to a training results set, and to intermediate results set, wherein the intermediate results set are associated with outputs of intermediate data processing elements represented by the respective machine learning inference pipelines representations; and wherein generating the target model is performed by training the target model as a student model based on the training set, the training results set, and the intermediate results set.

In some cases, the intermediate results set include at least one of: (a) an autoencoder residual; (b) a score; or (c) a signal importance weight.

In some cases, the training set is a synthetic training data set, generated using a machine learning generative model or a physical simulation.

In some cases, the generating of the target model includes partitioning of the target model into components according to resources of a target computing device that the target model is designed to be installed thereon.

In some cases, at least one of the data processing elements is a pre-processing element.

In some cases, the data pipeline representation and the common representation are Open Neural Network Exchange (ONNX) representations.

In some cases, the target model is designed to be installed on a target computing device.

In some cases, the optimization of the common representation is based on information on one or more resources of the target computing device.

In some cases, the target computing device is an in-vehicle computing device.

In some cases, at least part of a first machine learning inference pipeline of the machine learning inference pipelines is designed to operate on a first framework and at least part of a second machine learning inference pipeline of the machine learning inference pipelines is designed to operate on a second framework, different than the first framework.

In accordance with a second aspect of the presently disclosed subject matter, there is provided a method for unification of machine learning inference pipelines, the method comprising: obtaining, by a processing circuitry, one or more machine learning inference pipelines, each comprised of a sequence of one or more data processing elements, and each having (a) at least one input provided to the respective data processing element, and (b) at least one output provided by the respective data processing element, wherein the output of a given data processing element of the data processing elements, is the input of a subsequent data processing element of the sequence, if any, and wherein at least one of the data processing elements is a trained machine learning model; generating, by the processing circuitry, for each of the machine learning inference pipelines, a respective pipeline representation comprising representations of the sequence, based on the data processing elements, the inputs of the data processing elements, and the outputs of the data processing elements; merging, by the processing circuitry, the plurality of machine learning inference pipeline representations into a common representation, representing the plurality of machine learning inference pipeline representations; optimizing, by the processing circuitry, the common representation using one or more optimization schemes; and generating, by the processing circuitry, based on the common representation, a target model, wherein the target model consumes less resources than the machine learning inference pipelines.

In some cases, the optimization schemes include one or more of: (a) quantization; (b) pruning; or (c) knowledge distillation.

In some cases, the knowledge distillation utilizes teacher-student models.

In some cases, the method further comprising: executing, by the processing circuitry, a teacher model based on the common representation, on a training set, giving rise to a training results set, and to intermediate results set, wherein the intermediate results set are associated with outputs of intermediate data processing elements represented by the respective machine learning inference pipelines representations; and wherein generating the target model is performed by training the target model as a student model based on the training set, the training results set, and the intermediate results set.

In some cases, the intermediate results set include at least one of: (a) an autoencoder residual; (b) a score; or (c) a signal importance weight.

In some cases, the training set is a synthetic training data set, generated using a machine learning generative model or a physical simulation.

In some cases, the generating of the target model includes partitioning of the target model into components according to resources of a target computing device that the target model is designed to be installed thereon.

In some cases, at least one of the data processing elements is a pre-processing element.

In some cases, the data pipeline representation and the common representation are Open Neural Network Exchange (ONNX) representations.

In some cases, the target model is designed to be installed on a target computing device.

In some cases, the optimization of the common representation is based on information on one or more resources of the target computing device.

In some cases, the target computing device is an in-vehicle computing device.

In some cases, at least part of a first machine learning inference pipeline of the machine learning inference pipelines is designed to operate on a first framework and at least part of a second machine learning inference pipeline of the machine learning inference pipelines is designed to operate on a second framework, different than the first framework.

In accordance with a first aspect of the presently disclosed subject matter, there is provided a non-transitory computer readable storage medium having computer readable program code embodied therewith, the computer readable program code, executable by processing circuitry of a computer to perform a method for detecting potential information fabrication attempt on a webpage, the method comprising: obtaining, by a processing circuitry, one or more machine learning inference pipelines, each comprised of a sequence of one or more data processing elements, and each having (a) at least one input provided to the respective data processing element, and (b) at least one output provided by the respective data processing element, wherein the output of a given data processing element of the data processing elements, is the input of a subsequent data processing element of the sequence, if any, and wherein at least one of the data processing elements is a trained machine learning model; generating, by the processing circuitry, for each of the machine learning inference pipelines, a respective pipeline representation comprising representations of the sequence, based on the data processing elements, the inputs of the data processing elements, and the outputs of the data processing elements; merging, by the processing circuitry, the plurality of machine learning inference pipeline representations into a common representation, representing the plurality of machine learning inference pipeline representations; optimizing, by the processing circuitry, the common representation using one or more optimization schemes; and generating, by the processing circuitry, based on the common representation, a target model, wherein the target model consumes less resources than the machine learning inference pipelines.

### BRIEF DESCRIPTION OF THE DRAWINGS

In order to understand the presently disclosed subject matter and to see how it may be carried out in practice, the subject matter will now be described, by way of non-limiting examples only, with reference to the accompanying drawings, in which:

FIG. 1 is a schematic illustration of exemplary machine learning inference pipelines, in accordance with the presently disclosed subject matter;

FIG. 2 is a block diagram schematically illustrating one example of a system for machine learning inference pipelines unification and optimization, in accordance with the presently disclosed subject matter; and

FIG. 3 is a flowchart illustrating one example of a sequence of operations carried out for a machine learning inference pipelines unification and optimization process, in accordance with the presently disclosed subject matter.

### DETAILED DESCRIPTION

In the following detailed description, numerous specific details are set forth in order to provide a thorough understanding of the presently disclosed subject matter. However, it will be understood by those skilled in the art that the presently disclosed subject matter may be practiced without these specific details. In other instances, well-known methods, procedures, and components have not been described in detail so as not to obscure the presently disclosed subject matter.

In the drawings and descriptions set forth, identical reference numerals indicate those components that are common to different embodiments or configurations.

Unless specifically stated otherwise, as apparent from the following discussions, it is appreciated that throughout the specification discussions utilizing terms such as “generating”, “obtaining”, “merging”, “optimizing”, “executing” or the like, include action and/or processes of a computer that manipulate and/or transform data into other data, said data represented as physical quantities, e.g. such as electronic quantities, and/or said data representing the physical objects. The terms “computer”, “processor”, “processing resource”, “processing circuitry” and “controller” should be expansively construed to cover any kind of electronic device with data processing capabilities, including, by way of non-limiting example, a personal desktop/laptop computer, a server, a computing system, a communication device, a smartphone, a tablet computer, a smart television, a processor (e.g. digital signal processor (DSP), a microcontroller, a field programmable gate array (FPGA), an application specific integrated circuit (ASIC), etc.), a group of multiple physical machines sharing performance of various tasks, virtual servers co-residing on a single physical machine, any other electronic computing device, and/or any combination thereof.

The operations in accordance with the teachings herein may be performed by a computer specially constructed for the desired purposes or by a general-purpose computer specially configured for the desired purpose by a computer program stored in a non-transitory computer readable storage medium. The term “non-transitory” is used herein to exclude transitory, propagating signals, but to otherwise include any volatile or non-volatile computer memory technology suitable to the application.

As used herein, the phrase “for example,” “such as”, “for instance” and variants thereof describe non-limiting embodiments of the presently disclosed subject matter. Reference in the specification to “one case”, “some cases”, “other cases” or variants thereof means that a particular feature, structure or characteristic described in connection with the embodiment(s) is included in at least one embodiment of the presently disclosed subject matter. Thus, the appearance of the phrase “one case”, “some cases”, “other cases” or variants thereof does not necessarily refer to the same embodiment(s).

It is appreciated that, unless specifically stated otherwise, certain features of the presently disclosed subject matter, which are, for clarity, described in the context of separate embodiments, may also be provided in combination in a single embodiment.

Conversely, various features of the presently disclosed subject matter, which are, for brevity, described in the context of a single embodiment, may also be provided separately or in any suitable sub-combination.

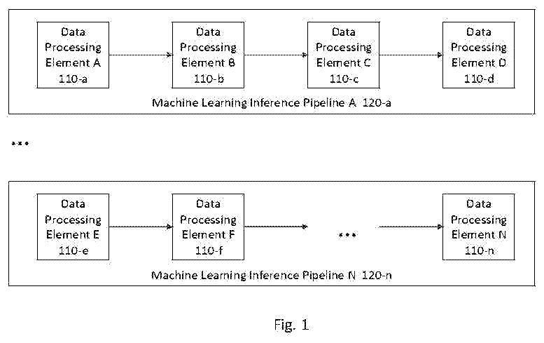

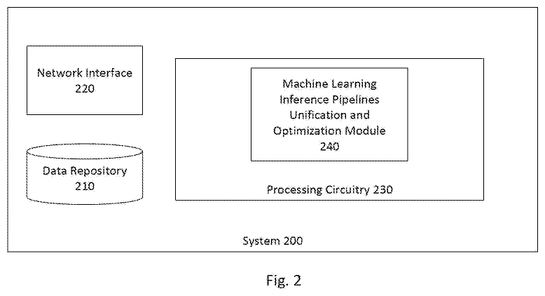

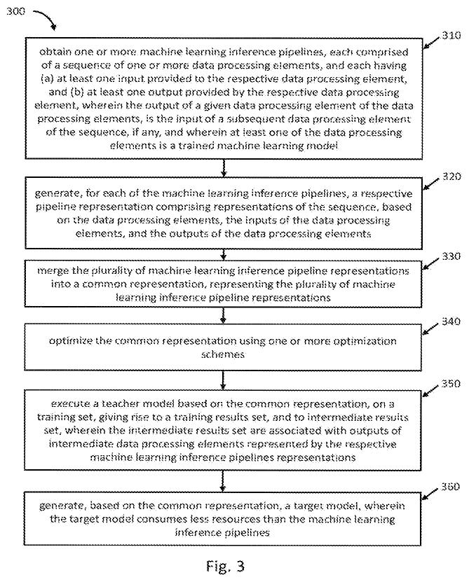

In embodiments of the presently disclosed subject matter, fewer, more and/or different stages than those shown in FIG. 3 may be executed. In embodiments of the presently disclosed subject matter one or more stages illustrated in FIG. 3 may be executed in a different order and/or one or more groups of stages may be executed simultaneously. FIGS. 1-2 illustrate a general schematic of the system architecture in accordance with an embodiment of the presently disclosed subject matter. Each module in FIGS. 1-2 can be made up of any combination of software, hardware and/or firmware that performs the functions as defined and explained herein. The modules in FIGS. 1-2 may be centralized in one location or dispersed over more than one location. In other embodiments of the presently disclosed subject matter, the system may comprise fewer, more, and/or different modules than those shown in FIGS. 1-2.

Any reference in the specification to a method should be applied mutatis mutandis to a system capable of executing the method and should be applied mutatis mutandis to a non-transitory computer readable medium that stores instructions that once executed by a computer result in the execution of the method.

Any reference in the specification to a system should be applied mutatis mutandis to a method that may be executed by the system and should be applied mutatis mutandis to a non-transitory computer readable medium that stores instructions that may be executed by the system.

Any reference in the specification to a non-transitory computer readable medium should be applied mutatis mutandis to a system capable of executing the instructions stored in the non-transitory computer readable medium and should be applied mutatis mutandis to method that may be executed by a computer that reads the instructions stored in the non-transitory computer readable medium.

Bearing this in mind, attention is drawn to FIG. 1, a schematic illustration of exemplary machine learning inference pipelines, in accordance with the presently disclosed subject matter.

Systems containing machine learning models can be used to monitor various signals to detect anomalies. Development of such signal monitoring systems can include the training of one or more machine learning inference pipeline (e.g. machine learning inference pipeline A 120-a, . . . , machine learning inference pipeline N 120-n), wherein each of the pipelines is a sequence of connected data processing elements (e.g. data processing element A 110-a, data processing element B 110-b, data processing element C 110-c, data processing element D 110-d, data processing element E 110-e, data processing element F 110-f, . . . , data processing element N 110-n) working together to perform tasks to achieve the goal. The output of a given data processing element, is the input of a subsequent data processing element of the sequence, if any connecting them into a chain of data processing.

The data processing elements can be one or more of: (a) pre-processing models, for example: normalizing incoming signals, buffering and/or aggerating signals, etc.; (b) machine learning models, for example: a neural network, a decision tree, etc.; (c) custom models, for example: a customized autoencoder model; (d) custom functions, for example: a change detection function, a scoring function; and (e) any other data processing element.

One or more machine learning inference pipelines can work together to monitor signals generated by a subject or an object. In some cases, the object is a component of a system (e.g. a module of a vehicle, communication traces of a network, performance information of a processor, etc.) to achieve a certain goal. The goal can be one or more of: anomaly detection, fault identification, fault prediction, remaining useful life estimation, etc.

In order to properly deploy the machine learning inference pipelines from a development environment to a target environment (such as: a resource constrained platform), for example: to an in-vehicle computing device, the machine learning inference pipelines are optimized as further detailed herein, inter alia with reference to FIG. 3.

The machine learning inference pipelines are designed to work on a specific data processing framework (such as: Apache Spark, Hadoop, Rink, etc.). It is to be noted that in some cases at least part of a first machine learning inference pipeline can be designed to operate on a first framework and at least part of a second machine learning inference pipeline can be designed to operate on a second framework, different than the first framework.

Having briefly described exemplary machine learning inference pipelines, attention is drawn to FIG. 2, a block diagram schematically illustrating one example of a system for machine learning inference pipelines unification and optimization, in accordance with the presently disclosed subject matter.

According to certain examples of the presently disclosed subject matter, system 200 can comprise a network interface 220 enabling connecting the system 200 to a network and enabling it to send and receive data sent thereto through the network, including in some cases receiving information such as: information of data processing elements, machine learning inference pipeline representations, information about a target computing device, etc. In some cases, the network interface 220 can be connected to a Local Area Network (LAN), to a Wide Area Network (WAN), or to the Internet. In some cases, the network interface 220 can connect to a wireless network. It is to be noted that in some cases the information, or part thereof, is transmitted to a target computing device.

System 200 can further comprise or be otherwise associated with a data repository 210 (e.g. a database, a storage system, a memory including Read Only Memory—ROM, Random Access Memory—RAM, or any other type of memory, etc.) configured to store data, including, inter alia, information of data processing elements, information of machine learning inference pipeline representations, information about a target computing devices, etc.

In some cases, data repository 210 can be further configured to enable retrieval and/or update and/or deletion of the data stored thereon. It is to be noted that in some cases, data repository 210 can be distributed. It is to be noted that in some cases, data repository 210 can be stored in on cloud-based storage.

System 200 further comprises processing circuitry 230. Processing circuitry 230 can be one or more processing circuitry units (e.g. central processing units), microprocessors, microcontrollers (e.g. microcontroller units (MCUs)) or any other computing devices or modules, including multiple and/or parallel and/or distributed processing circuitry units, which are adapted to independently or cooperatively process data for controlling relevant system 200 resources and for enabling operations related to system 200 resources.

The processing circuitry 230 comprises a machine learning inference pipelines unification and optimization module 240, configured to perform a machine learning inference pipelines unification and optimization process, as further detailed herein, inter alia with reference to FIG. 3.

Turning to FIG. 3, a flowchart illustrating one example of a sequence of operations carried out for a machine learning inference pipelines unification and optimization process, in accordance with the presently disclosed subject matter.

According to certain examples of the presently disclosed subject matter, system 200 can be configured to perform machine learning inference pipelines unification and optimization process 300, e.g. utilizing the machine learning inference pipelines unification and optimization module 240. The machine learning inference pipelines unification and optimization process 300 will allow system 200 to unify multiple machine learning inference pipelines (e.g. machine learning inference pipeline A 120-a, . . . , machine learning inference pipeline N 120-n) by merging them into one common representation and to generate a target model that is optimized based on the common representation. For this purpose, system 200 can be configured to obtain one or more machine learning inference pipelines, each comprised of a sequence of one or more data processing elements (e.g. data processing element A 110-a, data processing element B 110-b, data processing element C 110-c, data processing element D 110-d, data processing element E 110-e, data processing element F 110-f, . . . , data processing element N 110-n), and each having (a) at least one input provided to the respective data processing element, and (b) at least one output provided by the respective data processing element, wherein the output of a given data processing element of the data processing elements, is the input of a subsequent data processing element of the sequence, if any, and wherein at least one of the data processing elements is a trained machine learning model (block 310).

The data processing elements are linked together into a sequence of inputs and outputs in order to realize the purpose of the machine learning inference pipelines. In some cases, at least one of the data processing elements is a pre-processing element and at least one of the data processing elements is a machine learning model.

A non-limiting example of a development of machine learning inference pipelines can be a pipeline monitoring a specific vehicle function (e.g. airflow management) by a sequenced combination of data processing elements, where each data processing element in the pipeline is trained individually using the outcome of the previous data processing element training In this example, multiple machine learning inference pipelines exist wherein each machine learning inference pipeline corresponds to a specific vehicle function and is trained individually to monitor the normal behavior of the specific function.

System 200 can be further configured to generate, for each of the machine learning inference pipelines, a respective pipeline representation comprising representations of the sequence, based on the data processing elements, the inputs of the data processing elements, and the outputs of the data processing elements (block 320).

A pipeline representation of a given machine learning inference pipeline provides descriptions of a computation graph model, built-in operators and standard data types, that are used to define the given machine learning inference pipeline. Each computation dataflow graph is a list of nodes that form an acyclic graph. Each node represents a corresponding data processing element in the pipeline. Nodes have inputs and outputs. Each node is a call to an operator. The representation can include definitions for the data processing elements and their inputs and outputs in the pipeline sequence. The representation can allow framework interoperability. The representation can be in a textual format (such as: Extensible Markup Language (XML) format). In some cases, the data pipeline representations are Open Neural Network Exchange (ONNX) representations.

Continuing our non-limiting example above, each machine learning inference pipeline is represented using an ONNX representation, giving rise to a collection of pipelines representations in ONNX.

After generating the respective pipeline representations, system 200 is further configured to merge the plurality of machine learning inference pipeline representations into a common representation, representing the plurality of machine learning inference pipeline representations (block 330). The common representation can also be an ONNX representation wherein all machine learning inference pipeline representations are in represented using ONNX and are merged by system 200 into a single common representation also using an ONNX representation. The merging of the machine learning inference pipelines representations do not include at this phase optimization or overlap.

System 200 now optimizes the common representation using one or more optimization schemes such as: quantization, pruning or knowledge distillation (block 340). Quantization optimization is achieved by quantizing the data processing elements of the machine learning inference pipeline, their inputs and outputs into a small number of discrete values for reducing memory footprint and for replacing costly floating-point operations with integer operation. Pruning optimization is performed by system 200 by deleting some elements of some of the data processing elements (e.g. some of the neurons of a neural network model) of the machine learning inference pipeline to reduce memory footprint and to reduce the number of operations. Knowledge distillation can be achieved by system 200 optionally executing a teacher model based on the common representation, on a training set, giving rise to a training results set, and to intermediate results set, wherein the intermediate results set are associated with outputs of intermediate data processing elements represented by the respective machine learning inference pipelines representations (block 350). The knowledge distillation optimization can utilize intermediate results set including at least: an autoencoder residual; a score; or a signal importance weight. In some cases, the training set used for the knowledge distillation optimization is a synthetic training data set, generated using a machine learning generative model or a physical simulation

A non-limiting way to use knowledge distillation optimization with a teacher model is for the optimized model to learn and mimic the behavior of the teacher model by knowing how the teacher model reacts for all possible inputs. Some types of inputs might not be available in the training set (e.g. some samples of abnormal behavior). Synthetic data (generated, for example, by using machine learning generative model) or data generated using physic-based simulation can be created to sample the behavior of the teacher model and train the optimized model. This will allow the creation of an optimized model that can mimic the teacher model throughout the entire sampling space.

Another possible feature of the knowledge distillation optimization with a teacher model can be optimal repartitioning of the resulting optimized model into subgraphs or sub-networks in accordance with a target computing device on which the resulting model will execute. The sub-networking can adhere to the architecture of the computing elements (e.g. CPU cores) that can execute code in parallel on the target computing device. The data processing elements are partitioned into subcomponents and assigned to a specific computing element. During the training of the optimized model, a pre-partition of the training data is done in accordance with the target computing device's resources.

Utilizing the optimized common representation, system 200 can be further configured to generate, based on the common representation, a target model, wherein the target model consumes less resources than the machine learning inference pipelines (block 360). The target model is designed to be installed on a target computing device. The optimization of the common representation can be based on information on one or more resources of the target computing device. In these cases, the generating of the target model can optionally include partitioning of the target model into components according to resources of a target computing device that the target model is designed to be installed thereon.

In cases where the knowledge distillation optimization is used with a teacher model, the generation of the target model is done by training the target model as a student model based on the training set, the training results set, and the intermediate results set.

Continuing our non-limiting example above, the target computing device is an in-vehicle computing device and the optimized target model consumes less resources than the machine learning inference pipelines within the development environment. Without the unification and optimization the machine learning inference pipelines could not have executed on the in-vehicle computing device.

It is to be noted that, with reference to FIG. 3, some of the blocks can be integrated into a consolidated block or can be broken down to a few blocks and/or other blocks may be added. Furthermore, in some cases, the blocks can be performed in a different order than described herein. It is to be further noted that some of the blocks are optional (for example, block 350 is an optional block). It should be also noted that whilst the flow diagram is described also with reference to the system elements that realizes them, this is by no means binding, and the blocks can be performed by elements other than those described herein.

It is to be understood that the presently disclosed subject matter is not limited in its application to the details set forth in the description contained herein or illustrated in the drawings. The presently disclosed subject matter is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the present presently disclosed subject matter.

It will also be understood that the system according to the presently disclosed subject matter can be implemented, at least partly, as a suitably programmed computer. Likewise, the presently disclosed subject matter contemplates a computer program being readable by a computer for executing the disclosed method. The presently disclosed subject matter further contemplates a machine-readable memory tangibly embodying a program of instructions executable by the machine for executing the disclosed method.

1. A system for unification of machine learning inference pipelines, the system comprising a processing circuitry configured to:
obtain one or more machine learning inference pipelines, each comprised of a sequence of one or more data processing elements, and each having (a) at least one input provided to the respective data processing element, and (b) at least one output provided by the respective data processing element, wherein the output of a given data processing element of the data processing elements, is the input of a subsequent data processing element of the sequence, if any, and wherein at least one of the data processing elements is a trained machine learning model;
generate, for each of the machine learning inference pipelines, a respective pipeline representation comprising representations of the sequence, based on the data processing elements, the inputs of the data processing elements, and the outputs of the data processing elements;
merge the plurality of machine learning inference pipeline representations into a common representation, representing the plurality of machine learning inference pipeline representations;
optimize the common representation using one or more optimization schemes; and
generate, based on the common representation, a target model, wherein the target model consumes less resources than the machine learning inference pipelines.

2. The system of claim 1, wherein the optimization schemes include one or more of:
(a) quantization;
(b) pruning; or
(c) knowledge distillation.

3. The system of claim 2, wherein the knowledge distillation utilizes teacher-student models.

4. The system of claim 3, wherein the processing circuitry is further configured to:
execute a teacher model based on the common representation, on a training set, giving rise to a training results set, and to intermediate results set, wherein the intermediate results set are associated with outputs of intermediate data processing elements represented by the respective machine learning inference pipelines representations; and
wherein generating the target model is performed by training the target model as a student model based on the training set, the training results set, and the intermediate results set.

5. The system of claim 4, wherein the intermediate results set include at least one of:
(a) an autoencoder residual;
(b) a score; or
(c) a signal importance weight.

6. The system of claim 4, wherein the training set is a synthetic training data set, generated using a machine learning generative model or a physical simulation.

7. The system of claim 4, wherein the generating of the target model includes partitioning of the target model into components according to resources of a target computing device that the target model is designed to be installed thereon.

8. The system of claim 1, wherein at least one of the data processing elements is a pre-processing element.

9. (canceled)

10. (canceled)

11. (canceled)

12. The system of claim 1, wherein the target model is designed to be installed on a target computing device and wherein the target computing device is an in-vehicle computing device.

13. The system of claim 1, wherein at least part of a first machine learning inference pipeline of the machine learning inference pipelines is designed to operate on a first framework and at least part of a second machine learning inference pipeline of the machine learning inference pipelines is designed to operate on a second framework, different than the first framework.

14. A method for unification of machine learning inference pipelines, the method comprising:
obtaining, by a processing circuitry, one or more machine learning inference pipelines, each comprised of a sequence of one or more data processing elements, and each having (a) at least one input provided to the respective data processing element, and (b) at least one output provided by the respective data processing element, wherein the output of a given data processing element of the data processing elements, is the input of a subsequent data processing element of the sequence, if any, and wherein at least one of the data processing elements is a trained machine learning model;
generating, by the processing circuitry, for each of the machine learning inference pipelines, a respective pipeline representation comprising representations of the sequence, based on the data processing elements, the inputs of the data processing elements, and the outputs of the data processing elements;
merging, by the processing circuitry, the plurality of machine learning inference pipeline representations into a common representation, representing the plurality of machine learning inference pipeline representations;
optimizing, by the processing circuitry, the common representation using one or more optimization schemes; and
generating, by the processing circuitry, based on the common representation, a target model, wherein the target model consumes less resources than the machine learning inference pipelines.

15. The method of claim 14, wherein the optimization schemes include one or more of:
(a) quantization;
(b) pruning; or
(c) knowledge distillation.

16. The method of claim 15, wherein the knowledge distillation utilizes teacher-student models.

17. The method of claim 16, wherein the method further comprising:
executing, by the processing circuitry, a teacher model based on the common representation, on a training set, giving rise to a training results set, and to intermediate results set, wherein the intermediate results set are associated with outputs of intermediate data processing elements represented by the respective machine learning inference pipelines representations; and
wherein generating the target model is performed by training the target model as a student model based on the training set, the training results set, and the intermediate results set.

18. The method of claim 17, wherein the intermediate results set include at least one of:
(a) an autoencoder residual;
(b) a score; or
(c) a signal importance weight.

19. The method of claim 17, wherein the training set is a synthetic training data set, generated using a machine learning generative model or a physical simulation.

20. The method of claim 17, wherein the generating of the target model includes partitioning of the target model into components according to resources of a target computing device that the target model is designed to be installed thereon.

21. The method of claim 14, wherein at least one of the data processing elements is a pre-processing element.

22. (canceled)

23. (canceled)

24. (canceled)

25. (canceled)

26. The method of claim 14, wherein at least part of a first machine learning inference pipeline of the machine learning inference pipelines is designed to operate on a first framework and at least part of a second machine learning inference pipeline of the machine learning inference pipelines is designed to operate on a second framework, different than the first framework.

27. A non-transitory computer readable storage medium having computer readable program code embodied therewith, the computer readable program code, executable by processing circuitry of a computer to perform a method for detecting potential information fabrication attempt on a webpage, the method comprising:
obtaining, by a processing circuitry, one or more machine learning inference pipelines, each comprised of a sequence of one or more data processing elements, and each having (a) at least one input provided to the respective data processing element, and (b) at least one output provided by the respective data processing element, wherein the output of a given data processing element of the data processing elements, is the input of a subsequent data processing element of the sequence, if any, and wherein at least one of the data processing elements is a trained machine learning model;
generating, by the processing circuitry, for each of the machine learning inference pipelines, a respective pipeline representation comprising representations of the sequence, based on the data processing elements, the inputs of the data processing elements, and the outputs of the data processing elements;
merging, by the processing circuitry, the plurality of machine learning inference pipeline representations into a common representation, representing the plurality of machine learning inference pipeline representations;
optimizing, by the processing circuitry, the common representation using one or more optimization schemes; and
generating, by the processing circuitry, based on the common representation, a target model, wherein the target model consumes less resources than the machine learning inference pipelines.
